(19) United States
(12) Patent Application Publication
(10) Pub. No.: US 2003/0126165 A1
(43) Pub. Date: Jul. 3, 2003

(54) Method for defining and optimizing criteria used to detect a contextually specific concept within a paragraph

(76) Inventors: Irit Haviv Segal, Tel-Aviv (IL); Amir Winer, Tel-Aviv (IL)

Correspondence Address: Jefferson Perkins, PIPER RUDNICK, P.O. Box 64807, Chicago, IL, 60664-0807, US

(21) Appl. No.: 10/229,537

(22) Filed: Aug. 27, 2002

Related U.S. Application Data
(60) Provisional application No. 60/314,643, filed on Aug. 27, 2001.

(51) Int. Cl. G06F 17/30; G06F 17/21

(52) U.S. Cl. 707/206; 704/10

(57) ABSTRACT

The present invention discloses building blocks necessary for creating a self-populating directory in which individual paragraphs are mapped to folders, each folder being associated with a specific concept or idea. Criterion for specifying a desired context for the associated concept is inherited by hierarchically subordinate files. The inheritance of context criterion greatly simplifies the task of designing a self-populating directory. Also disclosed are routines for optimizing the level of recall and precision of the criterion used to populate the folder.

### RELATED APPLICATION(S)

This patent is related to U.S. application Ser. No. 09/845,196 filed May 1, 2001 entitled “METHOD FOR CREATING CONTENT ORIENTED DATABASES AND CONTENT FILES” which was submitted by the assignee of the present invention.

This patent is related to U.S. application Ser. No. xx,xxx,xxx, entitled “METHODOLOGY FOR CONSTRUCTING AND OPTIMIZING A SELF-POPULATING DIRECTORY” which was filed concurrent with the present invention.

Claim for Priority

This application claims priority under 35 U.S.C. 120 of U.S. Provisional Application Serial No. 60/314,643 filed Aug. 27, 2001, and which is entitled AUTOMATED FORMATION OF A MODULAR STRUCTURE OF KNOWLEDGE USING MULTI-LINGUAL WORD STEMS”.

### FIELD OF THE INVENTION

The methodology of the present invention is used to detect paragraphs that convey a particular concept or idea within an appropriate context. The methodology of the present invention facilitates the automatic mapping of paragraphs or other textual fragments to a directory.

### BACKGROUND

As used herein, the term “directory” refers to a hierarchical structure of folders where each folder represents an idea or concept, and the hierarchy defines the context of the idea or concept. Every folder in the directory is linked to a collection of files, documents, web addresses or the like. By manner of illustration, the internet portal YAHOO includes a directory of topics. See FIG. 1.

In a manually compiled directory, a directory editor determines the concepts expressed within each file and creates the linkage between the file and the folder(s) corresponding to each of the concepts. The human intervention associated with the manual compilation of a directory is likely to result in a high degree of precision, i.e., the files are likely to be relevant to the directory folder to which it is linked. Due to the sheer number of potentially relevant files, it is unlikley that the directory editor will be able to review each of the files. The directory editor may resort to heuristics to limit the universe of files. Thus, a manually compiled directory is likeley to have a low degree of recall.

Notably, the degree of recall is directly correlated to the size of the universe of files to be mapped to the various directories. The larger the universe of potential files the greater the likelihood of problems associated with recall levels.

Each file may contain numerous paragraphs, and each paragraph may convey multiple concepts. Thus the task of manually mapping individual paragraphs is significantly more difficult than the task of mapping files. For this reason, conventional directories map files and not paragraphs.

Morever, the universe of files (paragraphs) pertaining to a given field (topic) is continuously growing, thus exacerbating the recall problem.

For this reason, it has long been desired to automate the process of populating a directory.

Prior attempts to automate the population of a directory have used a Boolean search phrases to identify relevant files. However, it is exceedingly difficult to formulate a Boolean search phrase which balances the need for a high level of recall, i.e., the inclusion of all the files containing the search terms, against the need for a high level precision, i.e., the inclusion of only relevant files.

The accuracy and precision of the search phrase is dependent on the user's knowledge of the field of knoweldge of the directory. In order to achieve a high degree of recall, the user must specify all the various terms used to describe the target concept. Correspondingly, to improve the precision of the search results the user must attempt to weed out contextually irrelevant results using various combinations of Boolean operators.

Unfortunately, it is exceedingly difficult to create a search phrase which simulatenously maximizes the recall level and the precision of the search results (files) to be mapped to the directory.

Even the most modest computerized search engine is able to reliably search for the exact occurrence of a text string. However, the shifting contextual meaning of words creates a situation in which it is not sufficient to merely search for an exact text string. The search phrase must be painstakingly optimized to minimize irreleveant usages of the terminology without unduly reducing the level of recall.

Importantly, in conventional directories each folder has a unique search phrase which is independent of the search phrase of every other folder in the directory. The task of defining the search criteria for populating the directory is directly proportional to the number of folders in the directory. A typical hierarchical directory may have hundereds of folders where as a comprehensive directory may that conveys a whole field of knowledge may end up with over 100,000 folders (such as legal directory of Westlaw).

### SUMMARY OF THE INVENTION

The present invention discloses a method for defining a software folder used to construct a self-populating directory. Software folders are defined by providing a label which describes the concept associated with the folder; and a folder definition. The folder definition includes folder-specific criteria for detecting an expression of the concept and criteria inherited by hierarchically subordinate folders in the directory for detecting the context of the expression.

According to one aspect of the invention at least one Master Phrase is used to specify the criteria inherited by hierarchically subordinate folders in the directory for detecting the context of the expression.

According to another aspect of the invention at least one Stem Phrase is used to specify folder-specific criteria for detecting an expression of the concept.

According to another aspect of the invention the folder definition contains multi-lingual word stems.

The present invention further discloses a tool for optimizing the recall level of a folder definition having folder-specific criteria for detecting an expression of the concept.

The recall level optimization tool is provided with a collection of paragraphs, and a collection of noise words. Individual paragraphs in the collection of paragraphs are compared against the folder definition, and paragraphs not satisfying the folder definition criteria are extracted from the collection. Noise words are subsequently removed from the remaining paragraphs.

Sentences which do not contain word stems used to specify the criteria for detecting the expression of the concept are extracted from the collection of paragraphs, and a frequency table is compiled tabulating the combinations of one, two, three and four adjacent words within the sentences remaining in the collection of paragraphs.

The frequency table is used to identify combinations which may be indicative of the concept, and which are not already detected by the existing stem phrases.

The present invention further discloses a tool for optimizing the precision level of a folder definition having folder-specific criteria for detecting an expression of the concept and criteria inherited by hierarchically subordinate folders in the directory for detecting the context of the expression.

The precision level optimization tool is provided with a collection of paragraphs. Individual paragraphs in the collection of paragraphs are compared against the folder definition, and paragraphs not satisfying the folder definition criteria are extracted from the collection.

The remaining paragraphs are present to the user for examination. The user examines flags those paragraphs in which the concept appears within an irrelevelant context.

The user examines the collection of paragraphs to identify word(s) which recur in the flagged paragraphs at a substantially greater incidence than the non-flagged paragraphs, and modifies the folder definition to disqualify paragraphs using such word(s).

If no recurring word(s) are detected for excluding the flagged paragraphs from the folder, then the user tries to identify word stems which recur in the flagged paragraphs at a substantially greater incidence than the non-flagged paragraphs, and amends the folder definition to exclude such word stems.

If no recurring word stem is detected, then the user tries to identify Proximity Restriction(s) which exclude the flagged paragraphs at a substantially greater incidence than the non-flagged paragraphs, and amends the folder definition to include said Proximity Restriction(s).

If no suitable Proximity Restriction is detected, then the user tries to identify Order Restriction(s) which exclude the flagged paragraphs at a substantially greater incidence than the non-flagged paragraphs, and amends the folder definition to include said Order Restriction(s).

### BRIEF DESCRIPTION OF THE DRAWINGS

FIG. 1 is a screen shot of a sample directory;

FIG. 2 is a schematic drawing of a directory;

FIG. 3 is a stem phrase according to the present invention;

FIG. 4 is a stem group according to the present invention;

FIG. 5 is a sample Proximity Restriction according to the present invention;

FIG. 6 is a sample paragraph in which words satisfying the stem group of FIG. 5 are highlighted;

FIG. 7 is an Order Restriction according to the present invention;

FIG. 8 is a Combined Order-Proximity Restriction;

FIG. 9 is Multi-Stem Group according to the present invention;

FIG. 10 is a NOT Phrase according to the present invention;

FIGS. 11A-1 and 11a-2 depict the folder definition for three folders;

FIG. 11B is a sample directory for explaining the property of inheritance;

FIG. 12 is a Directory constructed from folders created using the methodology of the present invention;

FIG. 13 is a flow diagram of the algorithm used to optimize the precision level of the folder definition;

FIG. 14 shows two paragraphs, which satisfy the folder definition of FIG. 4;

FIG. 15 is a flow diagram of the algorithm used to optimize the recall level of the folder definition;

FIG. 16 contains a sample noise list for a legal directory;

FIG. 17 shows a collection of sentences containing the Concept Stems from FIG. 4; and

FIG. 18 is a table of the frequency of occurrence of combinations of one, two, three and four adjacent words taken from the sentences in FIG. 17.

### DETAILED DESCRIPTION OF THE PREFERRED EMBODIMENTS

The methodology of the present invention is the fundamental building block to the construction of an improved self-populating directory. The present invention is used to define the folders which are used to construct the improved self-populating directory. The method for constructing the directory is disclosed in a related application whose disclosure is incorporated by reference.

Every folder in a directory according to the present invention is linked to a collection of paragraphs. To be more precise, paragraphs are automatically classified onto the taxonomy (directory structure). The methodology of the present invention is used to automatically identify paragraphs (textual fragments) which convey a given idea.

According to the present invention a file is a document, web site or the like containing at least one paragraph of text. A paragraph is defined as a text string terminated by paragraph termination symbol such as “¶” or the like, or one or more blank lines. If the text in the file does not contain any recognized paragraph notation then the entire text string is considered to be a single paragraph.

The methodology of the present invention is used to detect paragraphs that convey a particular concept or idea within an appropriate context. As will be explained, the present invention pinpoints the precise paragraph within a multi-paragraph file conveying the specified idea or concept. However, the methodology may be readily adapted to operate on a different unit of text.

The methodology of the present invention reduces the burden to create a self-populating directory.

Moreover, the methodology of the present invention facilitates the mapping of paragraphs whereas conventional directories have difficulties mapping files.

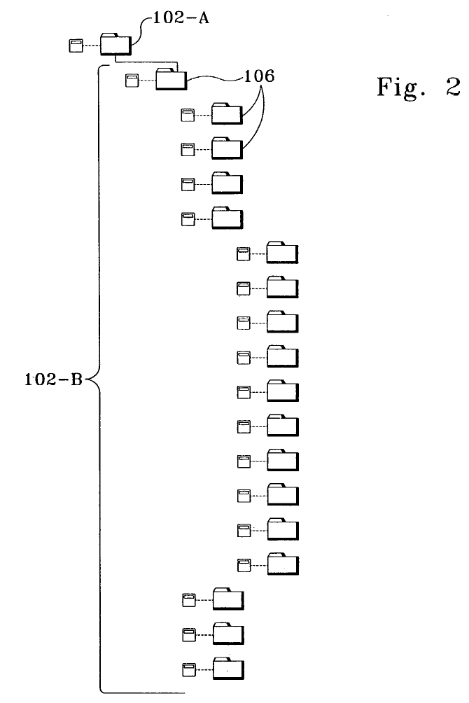

FIG. 2 is a sample directory 100 having a root folder 102-A and sub-folders 102-B. Reference numeral 102 is a generic reference to folders 102-A, 102-B.

Each folder 102 in the directory 100 is associated with a label 106 and a definition 108. The label 106 is a description of the folder's concept, and the definition 108 is the criteria used to detect the concept within a paragraph.

An important aspect of the methodology of the present invention relates to the unit of text which is interrogated for a concept. As noted previously according to the present invention the preferred unit of text is the paragraph. However, for some applications the preferred unit of text may be two or more paragraphs.

Roadmap

For the sake of comprehension, the present disclosure is split into four sections. Section I discloses the tools used to specify a folder definition 108, Section II discloses how to create a folder definition 108 using the aforementioned tools, Section III discloses an algorithm for optimizing the precision level of the folder definition; and Section IV discloses an algorithm for optimizing the recall level of the folder definition.

Section I Tools for Specifying the Folder Definition 108

The definition 108 is specified using word stems 110, where a word stem is an expression (“health care”), a word (“evaluation”) or a word fragment (“valu”). A word fragment is a word whose beginning (prefix) or end (suffix) has been truncated.

A word stem 110 is used to detect words (terms) in which the stem appears at the beginning, end or in middle of the word. The methodology of the present invention uses a series of special operators to specify the manner in which stems 110 are matched to words within the paragraph. Moreover, the invention uses special operators for specifying stem combinations within a paragraph.

Symbols key:

A hyphen (“-”) appended to the end of a stem 110 signifies a stem which captures only words starting with the stem, e.g., “duty-”.

A hyphen (“-”) appended to the front of a stem 110 signifies a stem which captures only words ending with the stem, e.g., “-duty”.

A hyphen (“-”) appended to both the front and end of a stem 110 signifies a stem which captures words in which the stem appears in the beginning, middle or end, e.g., “-valu-”.

An exact phase is designated through the use of dollar signs (“$”) appended to the front and end of a stem, e.g. “$act$”.

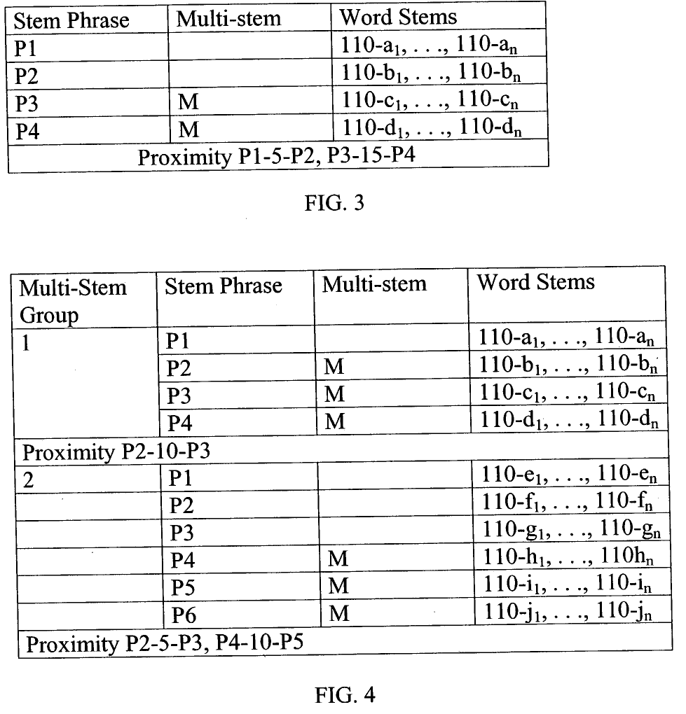

Stem Phrase (FIG. 3)

As used herein, a Stem Phrase 120 is a collection of word stems 110 that pertain to a given idea. FIG. 3 is a sample Stem Phrase 120 used to detect the legal concept “disclosure”.

As shown in FIG. 3, an OR operator, denoted by the symbol “|” interposed between two stems designates alternative stems, e.g., “duty | duties”.

A NOT operator denoted by an exclamation point “!”, e.g., “!health care”, is used to assure that a certain word stem 110 does not appear within the paragraph. The appearance of the stem 110 causes the paragraph to be disqualified from being mapped to a folder 102.

Stem Group (FIG. 4)

As used herein, a Stem Group 130 is a collection of one or more Stem Phrase(s) 120 that must appear within a paragraph in order to satisfy the folder definition 108. In the event that the Stem Group 130 contains two or more Stem Phrases 120, the criterion is the Boolean AND of the respective Stem Phrases 120.

As will be explained below the Stem Group 130 may optionally include a Proximity Restriction 132, an Order Restriction 134, and a Combined Order/Proximity Restriction 136.

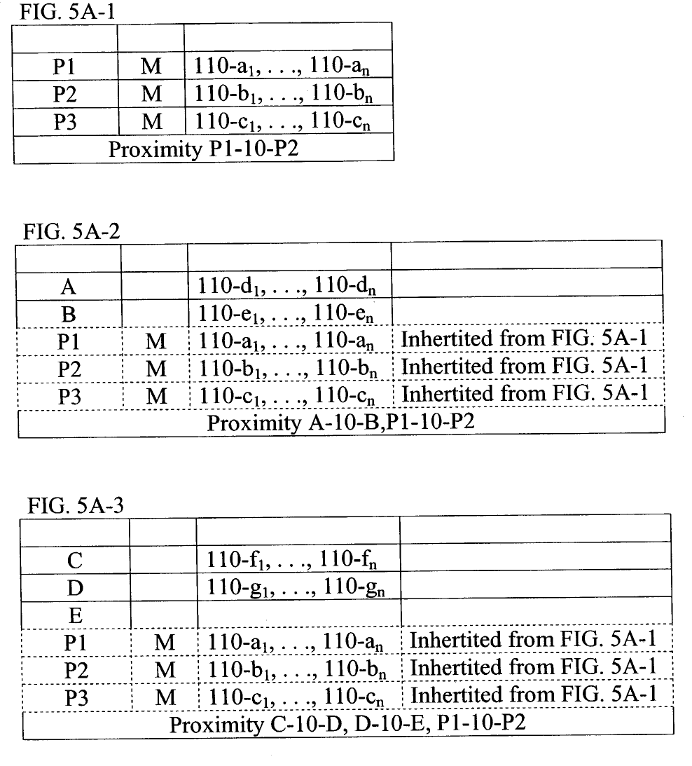

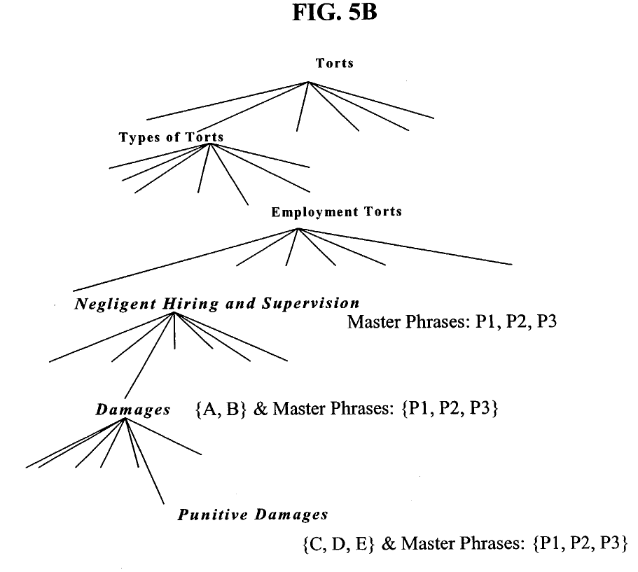

Proximity Restriction (FIG. 5)

The Proximity Restriction 132 enables the user to define the maximal distance between stems from two Stem Phrases 120. The Proximity Restriction 132 may be defined by the number of words or characters between stems from the respective Stem Phrases 120.

According to a preferred embodiment, the Proximity Restriction 132 is used on the paragraph level, meaning that each paragraph is evaluated to determine whether it satisfies the Proximity Restriction 132. However, it is possible to specify a different unit of text for evaluation.

In FIG. 5, P1, P2 and P3 are Stem Phrases 120, and the Proximity Restriction 132 uses the notation “P1-15-P2” to specify a 15 word proximity within a given paragraph between at least one term from Stem Phrase P1 and at least one term from Stem Phrase P2.

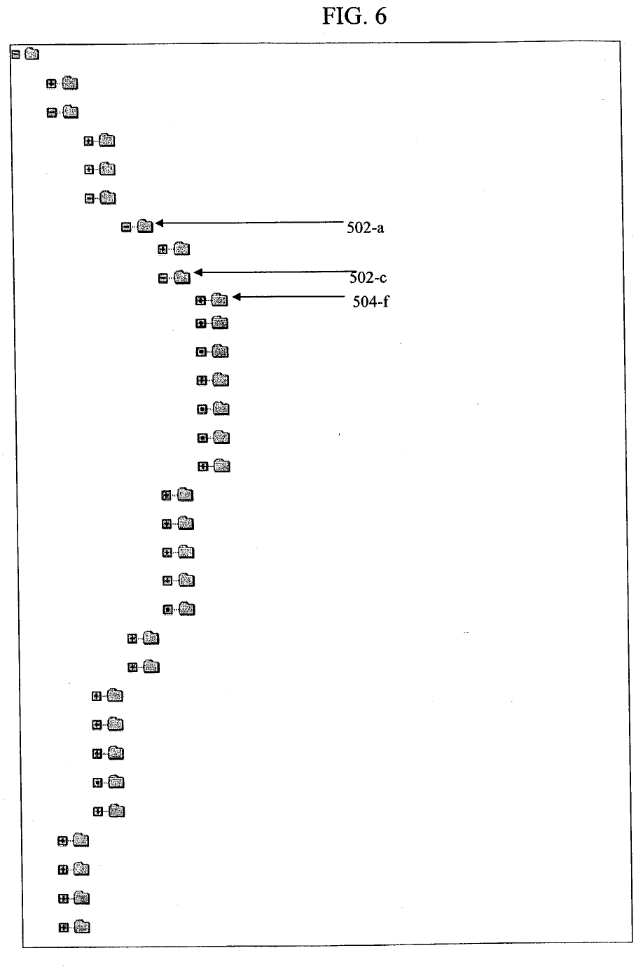

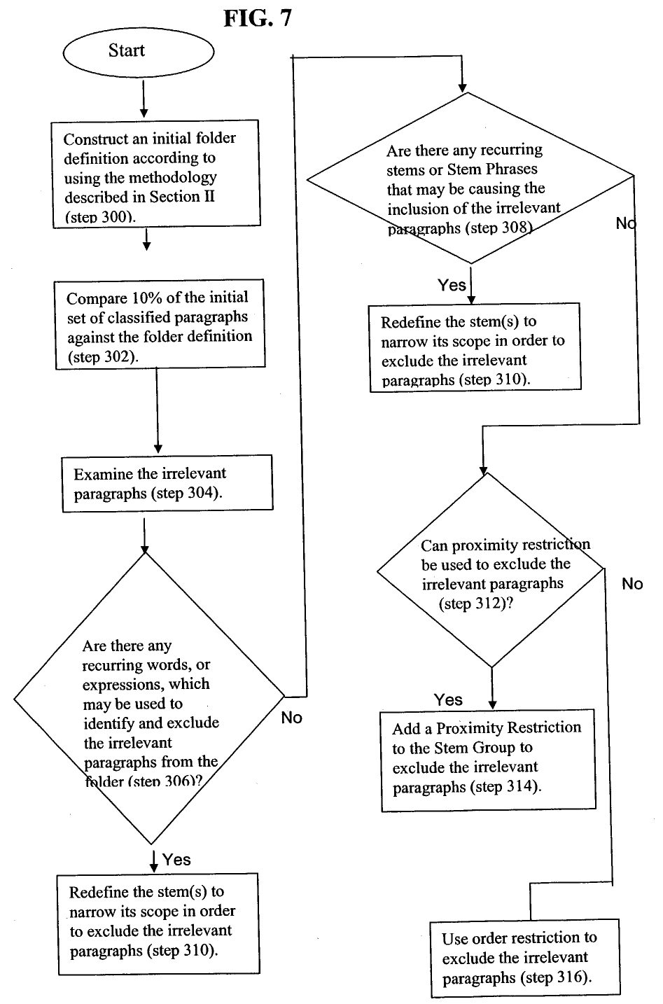

FIG. 6 is a sample paragraph in which the stems 110 from each of the stem phrases 120 from FIG. 5 are underlined showing that the Proximity Restriction 132 is satisfied.

Order Restriction (FIG. 7)

The Order Restriction 134 is used to define the order in which stems 110 from corresponding Stem Phrases 120 appear within a paragraph.

According to a preferred embodiment, the Order Restriction 134 is used on the paragraph level, meaning that each paragraph is evaluated to determine whether it satisfies the Order Restriction 134. However, as will be described below, it is possible to specify a different unit of text for evaluation.

FIG. 7 shows an Order Restriction 134 specifying that at least one stem from Stem Phrase P1 (120-a) should occur in the paragraph before at least one stem from Stem Phrase P2 (120-b).

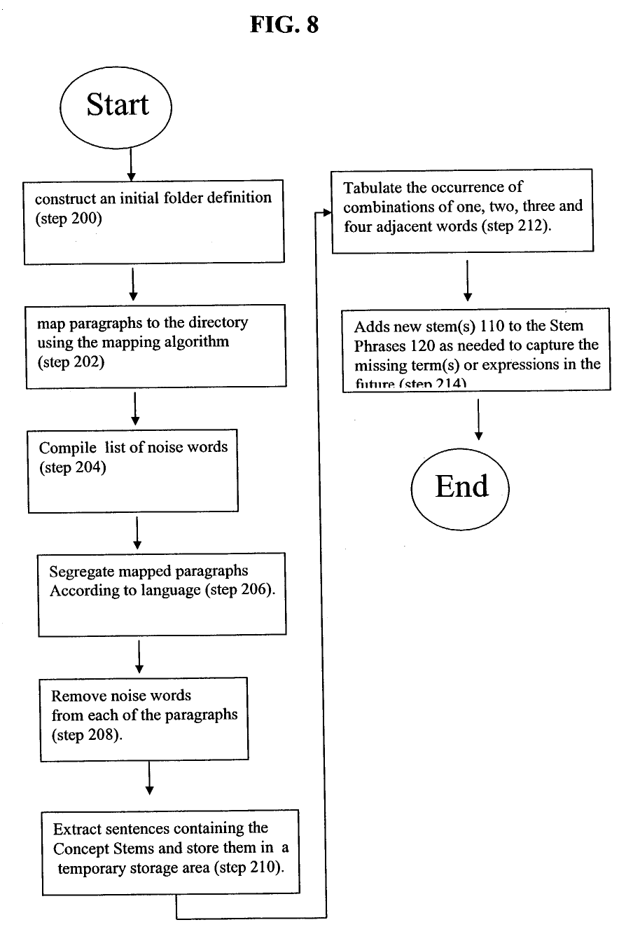

Combined Order-Proximity Restriction (FIG. 8)

The Order Restriction 134 may be combined with the Proximity Restriction 132 to form a Combined Order-Proximity Restriction 136. FIG. 8 shows a Combined Order-Proximity Restriction 136 which specifies that at least one stem from Stem Phrase P1 (120-c) should occur in the paragraph before a term from Stem Phrase P2 (120-d).

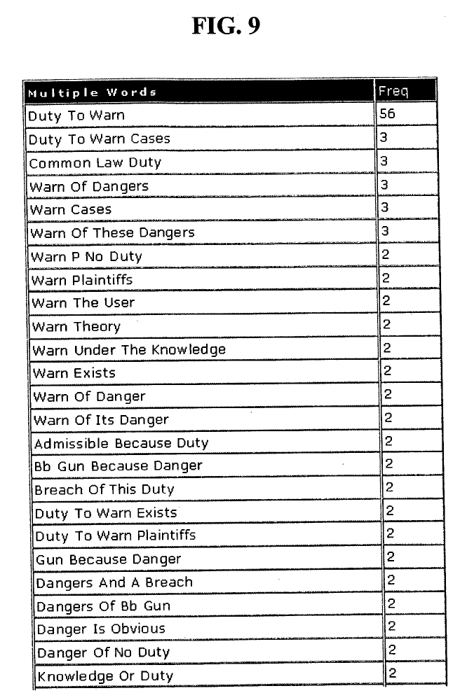

Multi Stem Group (FIG. 9)

A Multi Stem Group 138 is a union (Boolean OR) of two or more Stem Groups 120. A paragraph satisfying the criteria of at least one of the Stem Groups 120-a, 120-b, . . . , 120-n will satisfy the criteria of the Multi Stem Group 138.

FIG. 9 shows a sample Multi Stem Group 138 including Stem Groups 120-a, 120-b, 120-c which pertain to the subject of defenses to defamation torts.

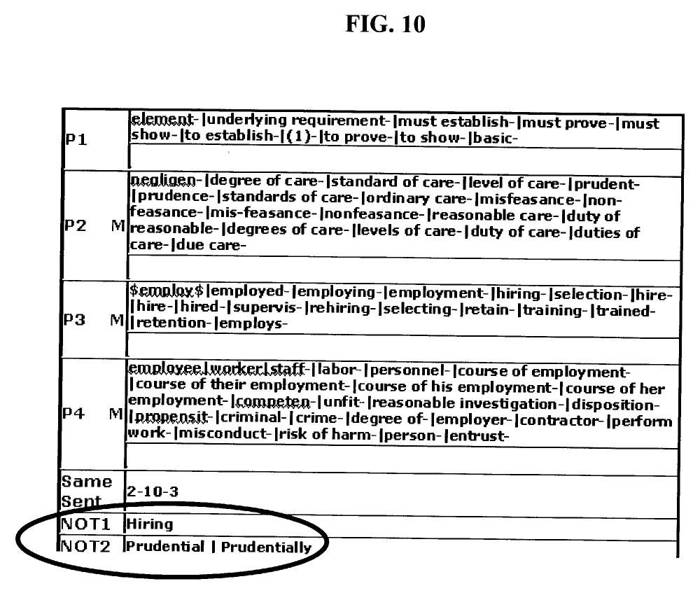

Not Phrase (FIG. 10)

A NOT phrase 140 (FIG. 10) is a special type of Stem Phrase 120 used to disqualify paragraphs which otherwise would be mapped or linked to a folder. The Not Phrase 140 over-rides the inclusion of a given paragraph specified by a Stem Phrase 120.

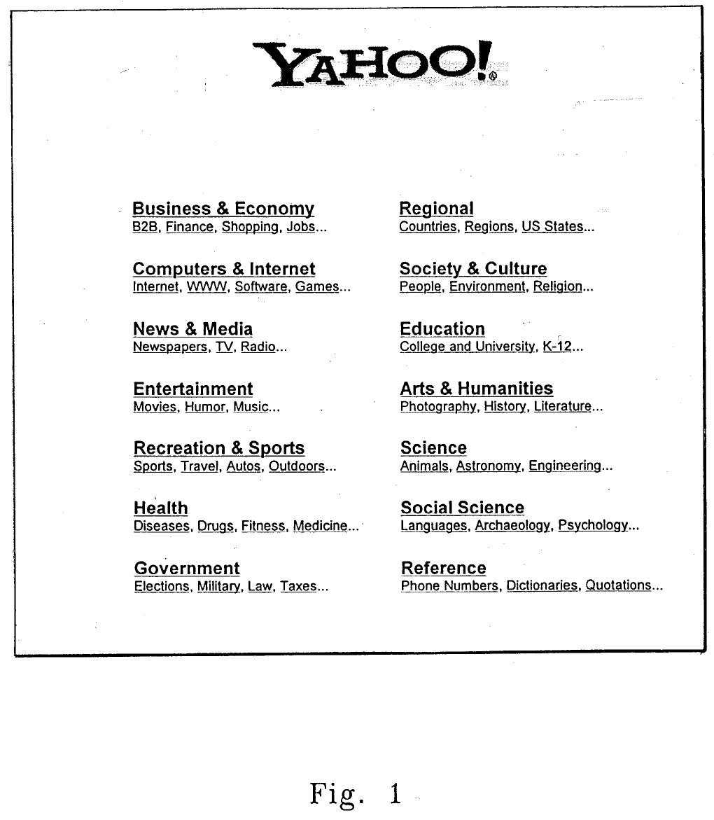

Master Phrase (FIGS. 11A-1 and 11A-2)

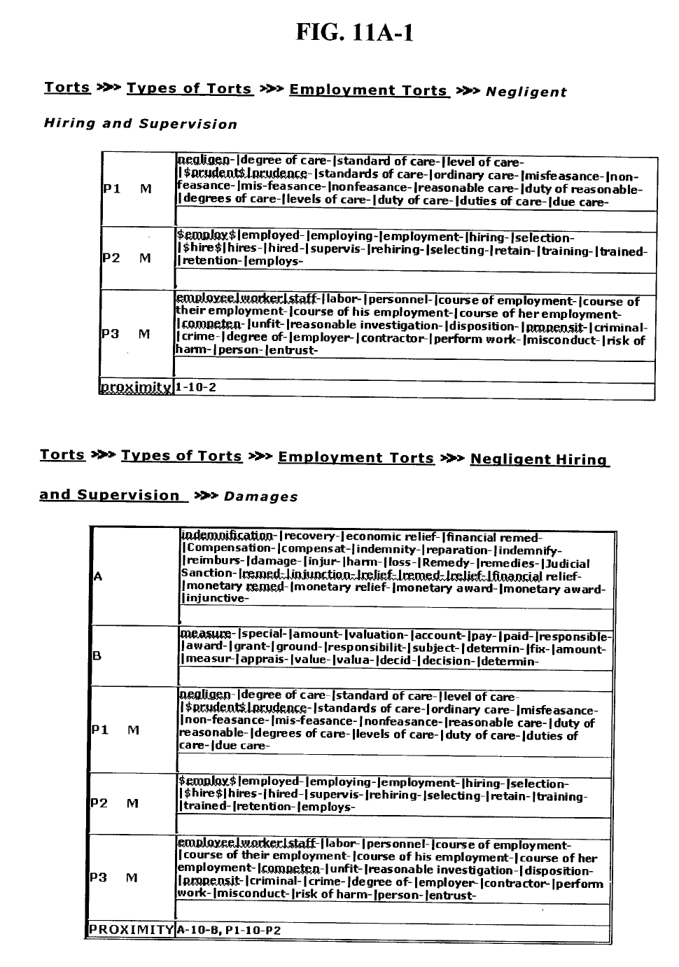

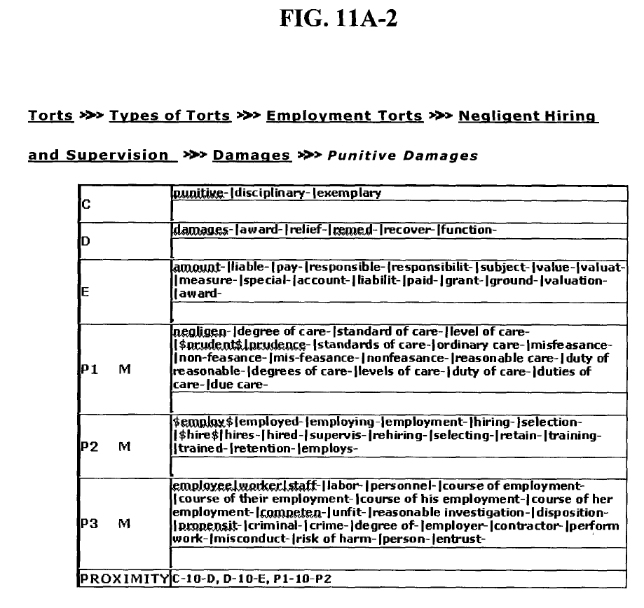

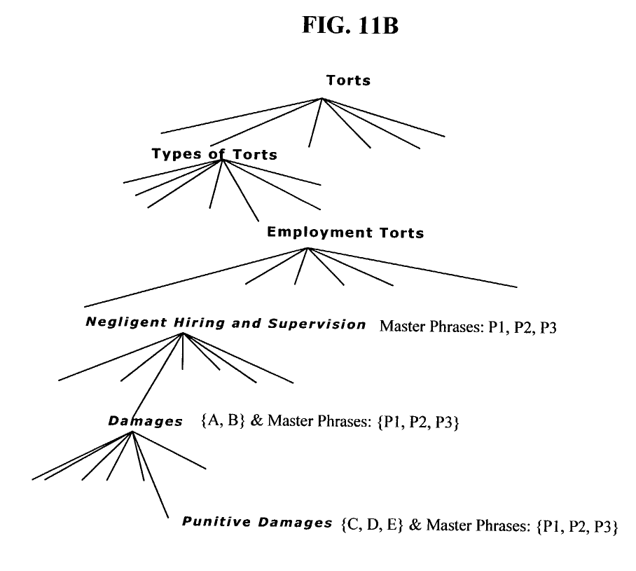

A Master Phrase 142 (FIG. 11A-1) is a special type of Stem Phrase 120 used to define inherited criteria. Like the Stem Phrase 120, the Master Phrase 140 is the Boolean OR of a collection of word stems 110. However, the criteria specified by a Stem Phrase 120 only applies to the immediate folder 102, and does not affect any other folder in the directory 100. In contrast, the criteria specified in the Master Phrase 140 are inherited by hierarchically subordinate folders 102 in the directory 100.

The use of a Master Phrase 140 simplifies the task of specifying a folder definition. The Master Phrase 140 is most advantageously used to define the context of hierarchically subordinate concepts. In this manner the folder definition 108 of a hierarchically subordinate folder 102 need only contain criteria for detecting the concept, since the context is inherited from a hierarchically superior folder 102.

The inheritance property of the Master Phrase 140 carries through to each hierarchically subordinate folder 102, i.e., the children, grand-children, great grant children etc of the folder 102. Moreover, changes to the Master Phrase 140 will change the inclusion criteria of the immediate folder and each of the hierarchically subordinate (child) folders.

FIG. 1A shows the definition 108-A of folders 172-A (Negligent Hiring and Supervision), 172-B (Elements of Negligent Hiring) and 172-C (Damages).

FIG. 11B is a sample schematic diagram of a directory 170 including folders 172-A, 172-B and 172-C.

The folder definition 108 for folder 172-A includes Master Phrases P1, P2 and P3.

The folder definition 108 for folder 172-B includes Stem Phrases A and B, and inherits Master Phrases P1, P2 and P3.

The folder definition 108 for folder 172-C includes Stem Phrases C, D and E, and inherits Master Phrases P1, P2 and P3.

In directory 170 (FIG. 11B) folders 172-B and 172-C are both hierarchically subordinate to folder 172-A. As such, folders 172-B and 172-C inherit the Master Phrases P1, P2 and P3 from the folder 172-A.

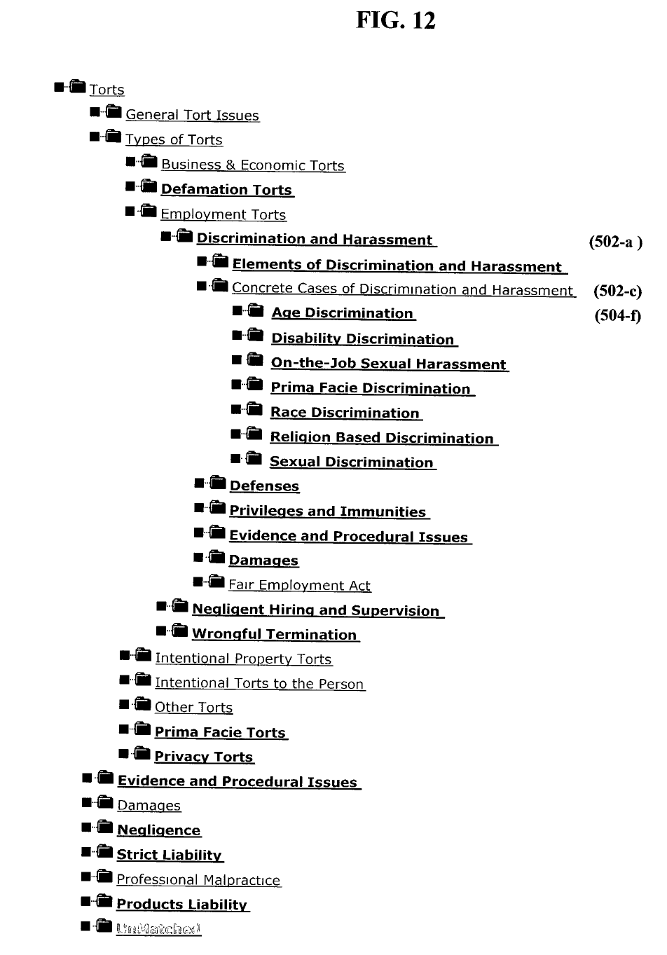

Section II Creating a Folder Definition (FIG. 12)

The full advantages of folders 102 created using the methodology of the present invention is most apparent when the folders are used to construct a self-populating directory 500 (FIG. 12) of the type described in U.S. application Ser. No. ______, entitled “METHODOLOGY FOR CONSTRUCTING AND OPTIMIZING A SELF-POPULATING DIRECTORY” which was filed concurrent with the present invention., hereinafter the ‘SELF-POPULATING DIRECTORY specification.

As described in the SELF-POPULATING DIRECTORY specification, the self-populating directory 500 is constructed from skeletal folders 502, framework folders 504 and combined skeletal-framework folders 506 which are all created using the methodology of the present invention. Thus each of these folders 502, 504, 506 include a label 106 and a definition 108.

As explained in the SELF-POPULATING DIRECTORY specification, the directory 500 includes a single root skeletal folder 502ᵣₒₒₜ.and plural subordinate skeletal folders 502. With exception of the root skeletal folder 502ᵣₒₒₜ, each folder 502, 504 and 506 is directly subordinate to only one folder.

The directory 500 includes one or more hierarchical levels of subordinate skeletal folders 502.

Framework folders 504 on a given branch B of the directory 500 are hierarchically subordinate to all other skeletal folders 502 on branch B.

Combined skeletal-framework folders 506 on a given branch B of the directory 500 are hierarchically subordinate to all other skeletal folders 502 and framework folders 504 on branch B.

As described above, the label 106 describes the concept which is being detected, and the definition 108 contains the word stems 110 etc used to detect the concept within the paragraph.

For ease of comprehension, the method for specifying the definition 108 for the skeletal folders, framework folders and combined skeletal-framework folders will be explained with reference to the following terminology.

Folders 502-a, 502-b, . . . , 502-n are skeletal folders;

Folders 504-a, 504-b, . . . , 504-n are framework folders, where a framework folder is hierarchically subordinate to at least one skeletal folder;

Folders 506-a, 506-b, . . . , 506-n are combined skeletal-framework folders;

Folder definition 108ₛₖₑₗₑₜₐₗ is the combination of stems used to detect the concept specified in the label 106 of a selected skeletal folder 502-a, 502-b, . . . , 502-n.

Folder definition 108_{framework} is the Boolean AND of:

[A] the combination of stems used to detect the concept specified in the label 106 of a selected framework folder 504-a, 504-b, . . . , 504-n; and

[B] the combination of stems used to detect the concept specified in the parent (most closely related) skeletal folder 502-a, 502-b, 502-n.

Folder definition 108_{combined} is the Boolean AND of:

[A] the combination of stems used to detect the concept specified in the label 106 of a selected combined skeletal-framework folder 506-a, 506-b, . . . , 506-n; and

[B] the combination of stems used to detect the concept specified in the grandparent skeletal folder 502-a, 502-b, . . . , 502-n, i.e. the parent of the most closely related skeletal folder 520.

In the directory 500 shown in FIG. 12, folder 502-c is the parent skeletal folder for framework folder 504-f, because it is the most closely related skeletal folder 502. Correspondingly, folder 502-a is the grant-parent skeletal folder for framework folder 504-f, because it is parent of skeletal folder 502-c.

Mapping Paragraphs to a Directory

The folder definition 108 is used to detect paragraphs which convey the concept contained in the label 106. A directory 500 is populated by iteratively comparing each paragraph against each of the folder definitions 108 in the directory 500. Paragraphs which satisfy the criterion of a given folder definitions 108 are mapped to the folder. This process is described in U.S. application Ser. No. 09/845,196 filed May 1, 2001 entitled “METHOD FOR CREATING CONTENT ORIENTED DATABASES AND CONTENT FILES”.

Multilingual Capabilities

As described above, the folder definition 108 is essentially a collection of word stems 110, where the stem phrases 120, stem groups 130, and multi-stem groups 138 specify the manner in which the stems 110 must appear within a paragraph for the paragraph to be mapped to the folder. The folder definition 108 is used to detect the concept specified in the folder's label 106.

The methodology of the present invention may be used to create a multi-lingual directory simply by providing additional stem groups 130 within the folder definition 108. Notably, the multi stem group 138 may be provided with stem groups 130 in any number of different languages.

As described previously, each folder is associated with a particular concept, the concept is universal to all languages. A multi-lingual directory eliminates the need to provide separate directory for each language. In a multi-lingual directory according to the present invention the language the user uses to navigates through the directory is independent of the language of the paragraphs mapped to the directory. Thus, a user may use English to locate a desired folder within the multi-lingual directory, and then may retrieve paragraphs mapped to the folder in English, French, German etc.

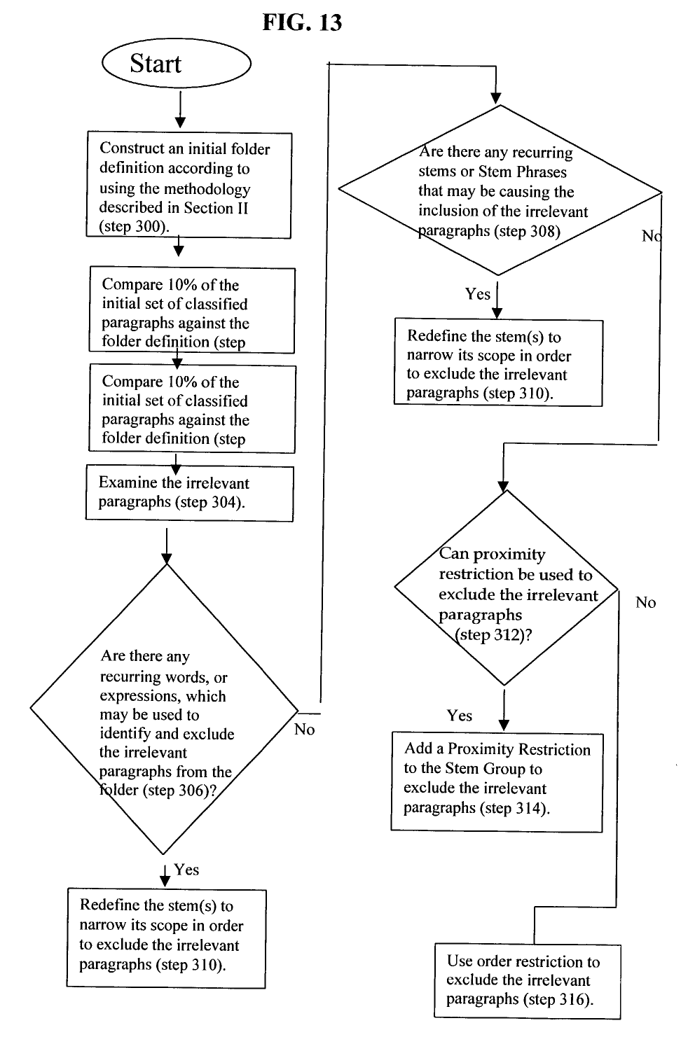

Section III Optimization of Precision Level (FIG. 13)

FIG. 13 is a flow diagram of the algorithm for improving the precision of a folder definition 108 according to the present invention.

The process begins with the construction of an initial folder definition 108 using the methodology described in Section II (step 300).

A sample of 10% from the initial set of classified paragraphs are compared against the folder definition 108, and paragraphs satisfying the criteria of the definition 108 are presented to the user (step 302).

The user examines the paragraphs to detect irrelevant paragraphs (step 304), where irrelevelant paragraphs are paragraphs which are not contextually relevant. The displayed paragraph matched all the requisite stem combinations, but the concept detected is used in an irrelevant context. Thus, the folder definition 108 needs to be adjusted to exclude the irrelevant context.

Examine the irrelevant paragraphs to detect recurring words, or expressions, which may be used to identify and exclude the irrelevant paragraphs from the folder (step 306). These words or expressions are then used to create Not phrases to exclude the irrelevant paragraphs from the folder.

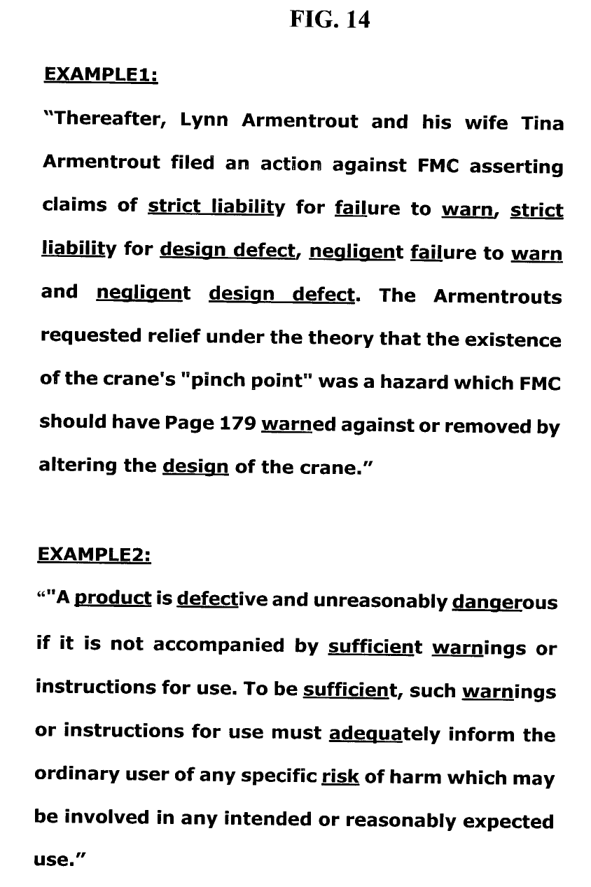

In FIG. 14 paragraphs PAR-1 and PAR-2 both satisfy the folder definition 108 of FIG. 4. The context of the concept detected in PAR-1 differs from the context of the context of the concept detected in PAR-2. In step 306 the user is attempting to identify particular words which signal the irrelevant context.

If no recurring word or expression is detected for excluding the irrelevant paragraphs from the folder in step 306, then examine the irrelevant paragraphs to detect recurring stems or Stem Phrases that may be causing the inclusion of the irrelevant paragraphs (step 308).

If a recurring stem or Stem Phrase is detected (in step 308), then redefine the stem(s) to narrow its scope in order to exclude the irrelevant paragraphs (step 310).

By manner of example, the Stem Phrase may be changed to include a restriction on the stem so that it is unable to capture the initial set of words or expressions. The Stem Phrase may also be changed to include restrictions regarding the positioning of the stem within the words (Starting only, Ending only, and Exact phrase).

If no recurring word or expression is detected in steps 306 or 308, then examine whether a Proximity Restriction may be used to exclude the irrelevant paragraphs (step 312). If so, then add a Proximity Restriction to the Stem Group to exclude the irrelevant paragraphs (step 314).

If no recurring word or expression is detected in steps 306, 308 or 312, examine whether an Order Restriction may be used to exclude the irrelevant paragraphs (step 316). If so, then add an Order Restriction to the Stem Phrases to exclude the irrelevant paragraphs.

It should be appreciated that if any of the steps 306, 308, 312, 314 or 316 drastically reduces the number of paragraphs identified as containing the target concept or idea, then the restriction must be reevaluated to determine whether the restriction has eliminated relevant paragraphs, i.e. caused a recall level decrease.

In the preceding explanation of the methodology of the present invention, the paragraph was used the fundamental unit for capturing an idea. However, one of ordinary skill in the art will appreciate that circumstances may exist in which the use of a paragraph may not prove to be an appropriate unit for capturing an idea. In such cases the methodology of the present invention may be adapted to utilize a Textual Fragment whose length may be defined in terms of a number of sentences it contains, or it may be defined as one or more paragraphs.

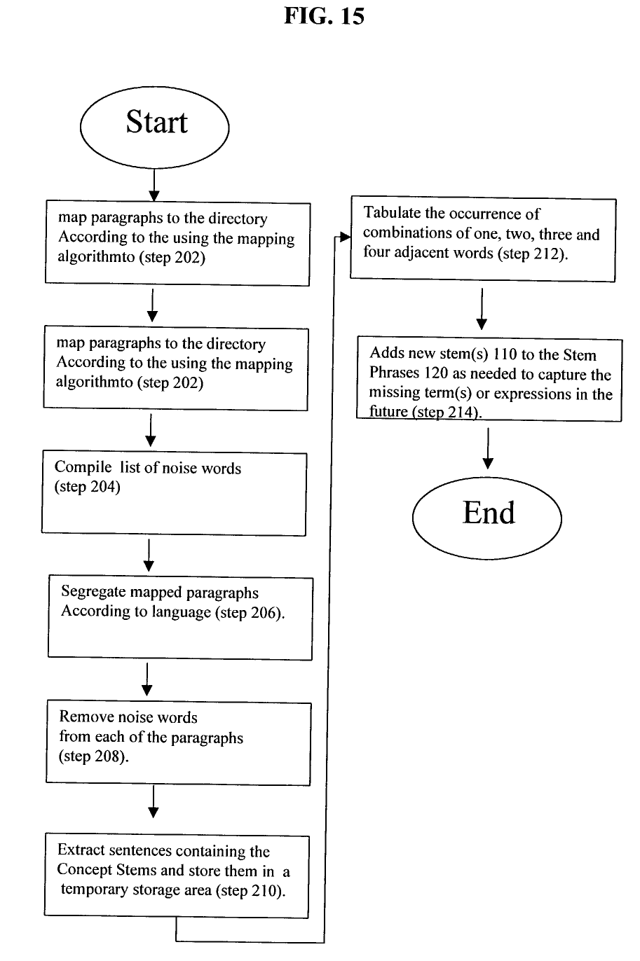

Section IV Optimization of Recall Level (FIG. 15)

FIG. 15 is a flow diagram of the algorithm used to optimize the recall level of the folder definition 108.

The algorithm of FIG. 15 is performed on a folder-by folder basis for each folder in the directory. In the case of a multi-lingual directory, the algorithm is separately executed for each language in every folder of the directory.

The process begins with the construction of an initial folder definition 108 using the methodology described in Section II (step 200).

A sample set of paragraphs are compared against the folder definition 108, and paragraphs satisfying the criteria of the definition 108 are mapped to a folder (step 202) using the methodology disclosed in U.S. application Ser. No. 09/845,196 filed May 1, 2001 entitled “METHOD FOR CREATING CONTENT ORIENTED DATABASES AND CONTENT FILES”.

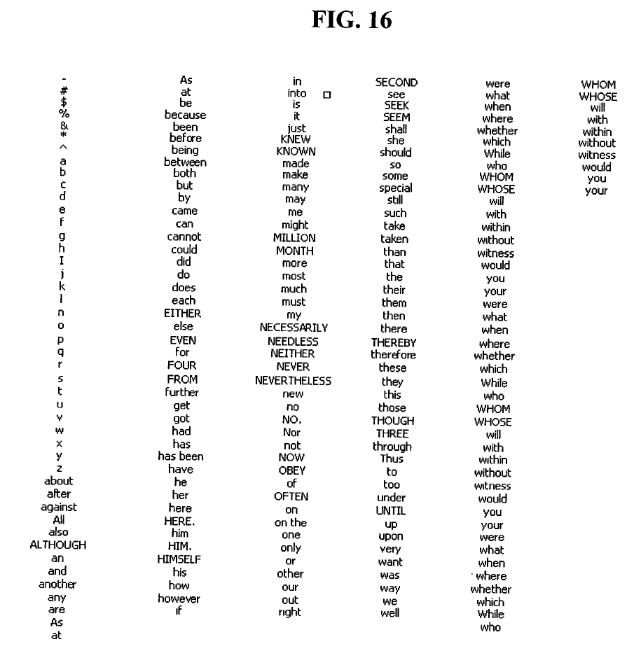

A list of noise words is compiled (step 204), where noise words are defined as words that do not have relevance to the directory as a whole. Such noise words typically include digits, dates, seasons, punctuation, single letters, symbols such as “&”, currency symbols, participles such as “a”, an”, “the”, and the like. FIG. 16 contains a sample noise list for an English language legal directory.

In the case of a multi-lingual directory, separate noise lists are compiled for each language.

Next, the paragraphs mapped in step 202 are segregated by language (step 206).

The noise words are removed from each of the paragraphs (step 208).

As described above each folder definition 108 must contain Stem Phrases 120 used to detect the concept (label 106) of the folder. In addition, the folder may include stem phrases 120 for detecting the context of the concept, e.g. Master Phrases 142.

The stems 110 which collectively form the Stem Phrase(s) 120 used to detect the folder concept are termed Concept Stems 110-a. See FIG. 11A.

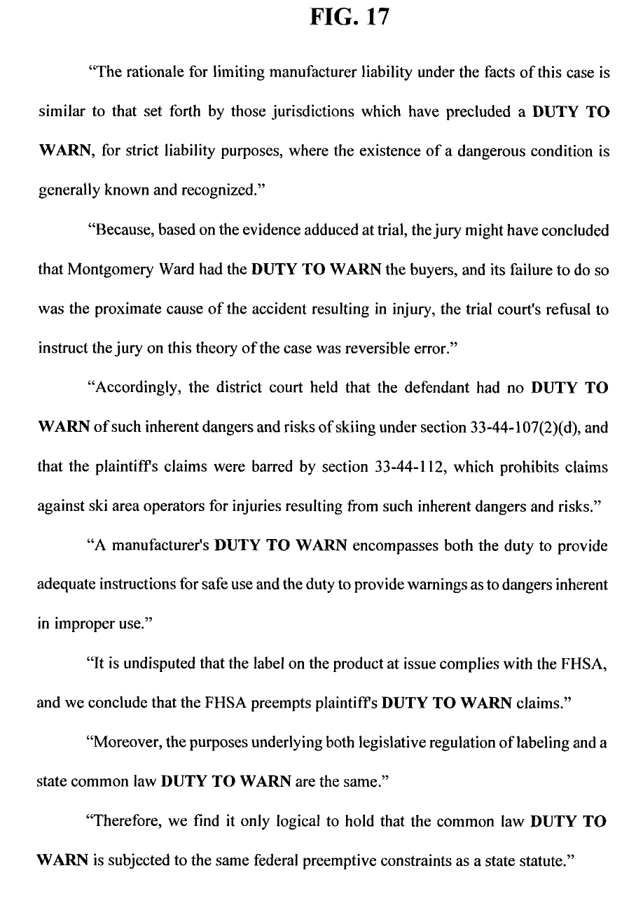

Each of the paragraphs mapped to the folder satisfies the criteria of the definition 108. Consequently, the Concept Stems 110-a must appear within each of the mapped paragraphs. Sentences containing the Concept Stems 110-a are extracted and stored in a temporary storage area (step 210). See FIG. 17.

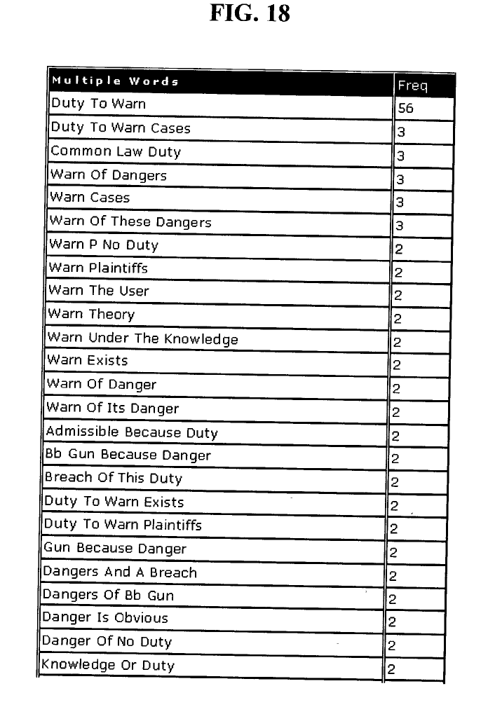

The frequency of occurrence of combinations of one, two, three and four adjacent words is tabulated (step 212). See FIG. 18.

The user visually examines the frequency lists to find terms or expressions which are not already detected by the existing stem phrases 120, and adds new stem(s) 110 to the Stem Phrases 120 as needed to capture the missing term(s) or expressions in the future (step 214).

It should be appreciated that a high frequency of occurrence is likely to indicate an expression relevant to the idea or concept of the folder.

While the invention has been described with reference to certain preferred embodiments, as will apparent to those of ordinary skill in the art, certain changes and modifications can be made without departing from the scope of the invention as defined by the following claims.

We claim:

1. A methodology for defining a software folder used to construct a self-populating directory, comprising the steps of:
providing a label describing a concept to be associated with the folder; and
providing a folder definition having folder-specific criteria for detecting an expression of the concept and criteria inherited by hierarchically subordinate folders in the directory for detecting the context of the expression.

2. The methodology according to claim 1, wherein at least one Master Phrase is used to specify the criteria inherited by hierarchically subordinate folders in the directory for detecting the context of the expression.

3. The methodology according to claim 1, wherein at least one Stem Phrase is used to specify folder-specific criteria for detecting an expression of the concept.

4. The methodology according to claim 1, wherein said folder definition contains multi-lingual word stems.

5. A tool for optimizing the recall level of a folder definition having folder-specific criteria for detecting an expression of the concept, comprising:
providing a collection of paragraphs;
providing a collection of noise words;
comparing each paragraph in the collection of paragraphs against the folder definition, and extracting from the collection any paragraph not satisfying the folder definition criteria;
extracting noise words contained in the collection of noise words from the collection of paragraphs;
extracting sentences from the collection of paragraphs which do not contain word stems used to specify the criteria for detecting the expression of the concept;
tabulating and outputting the frequency that combinations of one, two, three and four adjacent words occur within the sentences remaining in the collection of paragraphs; and
wherein the user visually examines the frequency table to find combinations indicative of the concept, which are not already detected by the existing stem phrases.

6. A tool for optimizing the precision level of a folder definition having folder-specific criteria for detecting an expression of the concept and criteria inherited by hierarchically subordinate folders in the directory for detecting the context of the expression, comprising:
providing a collection of paragraphs;
comparing each paragraph in the collection of paragraphs against the folder definition, and extracting from the collection any paragraph not satisfying the folder definition criteria;
examine the collection of paragraphs and flag those paragraphs in which the concept appears within an irrelevelant context;
examine the collection of paragraphs to identify word(s) which recur in the flagged paragraphs at a substantially greater incidence than the non-flagged paragraphs, and modify the folder definition to disqualify paragraphs using such word(s);
if no recurring word(s) are detected for excluding the flagged paragraphs from the folder, then identify word stems which recur in the flagged paragraphs at a substantially greater incidence than the non-flagged paragraphs, and amend the folder definition to exclude such word stems;
if no recurring word stem is detected, then identify Proximity Restriction(s) which exclude the flagged paragraphs at a substantially greater incidence than the non-flagged paragraphs, and amend the folder definition to include said Proximity Restriction(s); and
if no suitable Proximity Restriction is detected, then identify Order Restriction(s) which exclude the flagged paragraphs at a substantially greater incidence than the non-flagged paragraphs, and amend the folder definition to include said Order Restriction(s).
